(19) United States
(12) Patent Application Publication
(10) Pub. No.: US 2001/0003726 A1
(43) Pub. Date: Jun. 14, 2001

(54) INITIATION SYSTEM COMPRISING AN AMINO ALCOHOLATE LIGAND FOR ANIONIC COPOLYMERIZATION OF (METH)ACRYLIC MONOMERS AND PROCESS USING SAME

(76) Inventors: JEROME MARCHAL, BORDEAUX (FR); YVES GNANOU, TALENCE (FR); MICHEL FONTANILLE, TALENCE (FR)

Correspondence Address: PENNIE AND EDMONDS, 1155 AVENUE OF THE AMERICAS, NEW YORK, NY, 100362711

(21) Appl. No.: 09/058,503

(22) Filed: Apr. 10, 1998

(30) Foreign Application Priority Data
Apr. 10, 1997 (FR) 97 04469

(51) Int. Cl. B01J 23/04

(52) U.S. Cl. 502/154; 526/318.4; 526/319; 502/155; 502/157; 502/171

(57) ABSTRACT

The initiation system is composed of at least one initiator and at least one amino alcoholate of the formula:

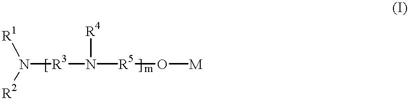

wherein R¹, R² and R⁴ each independently represent an alkyl radical, linear or branched, containing 1 to 8 carbon atoms or an arylalkyl radical, an alkylaryl or aryl radical; R³ and R⁵ each independently represent an alkylene radical, linear or branched, containing 2 to 8 carbon atoms, whether or not substituted by a C₁- C₈ alkyl radical or an aryl radical or an arylalkylene radical or an arylene radical; M designates an alkaline metal and m is equal to 0 or a whole number from 1 to 6. Application of the present invention is to the preparation of (meth)acrylic (co)polymers (homopolymers, block or statistical copolymers).

### BACKGROUND OF THE PRESENT INVENTION

1. Technical Field

The present invention relates to an initiation system for anionic polymerization of (meth)acrylic monomers and also ethylenically-unsaturated monomers; this new initiation system permits good control of the anionic polymerization of these monomers, particularly at high temperatures.

Anionic polymerization of (meth)acrylic monomers is often complicated by secondary reactions of the monomers, both with the initiator and the terminal radical of growing anionic chains, and due to termination and chain transfer reactions. However, this type of polymerization is interesting because polymers with a well-defined structure are obtained if it is conducted under carefully controlled conditions, often requiring the use of very low polymerization temperatures to minimize or eliminate termination and chain transfer reactions.

2. Description of Related Art

Research has been undertaken to improve the control of (meth)acrylic monomer polymerization and thus to avoid secondary reactions.

In European Patent Application EP-A-0524054, the anionic polymerization of alkyl (meth)acrylates using an initiation system comprising a monofunctional or difunctional initiator and a ligand formed by an alkoxy alcoholate of an alkaline metal is described.

With this process, polymerization is well controlled, especially at low temperatures.

An initiation system permitting well-controlled anionic polymerization that is used under conditions easy to create in industry and, in particular, is usable at higher temperatures, is still being sought.

### SUMMARY OF THE INVENTION

The initiation system is composed of at least one initiator and at least one amino alcoholate of the formula:

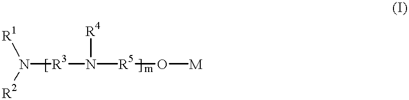

wherein R¹, R² and R⁴ each independently represent an alkyl radical, linear or branched, containing 1 to 8 carbon atoms or an arylalkyl radical, an alkylaryl or aryl radical; R³ and R⁵ each independently represent an alkylene radical, linear or branched, containing 2 to 8 carbon atoms, whether or not substituted by a C₁-C₈ alkyl radical or an aryl radical or an arylalkylene radical or an arylene radical; M designates an alkaline metal and m is equal to 0 or a whole number from 1 to 6. Application of the present invention is to the preparation of (meth)acrylic (co)polymers (homopolymers, block or statistical copolymers).

DESCRIPTION OF THE PREFERRED EMBODIMENTS

In particular, a means for preparing poly(methyl methacrylate) with a level of syndiotactic triads greater than that which is obtained in conventional free radical polymerization at the same temperature (e.g., the level of syndiotactic triads is about 50% to 60% in free radical polymerization) is being sought.

The object of this invention therefore is first an initiation system for anionic polymerization of (meth)acrylic monomers and possibly ethylenically-unsaturated monomers that are polymerized with these (meth)acrylic monomers, composed of:

(1) at least one initiator, and

(2) at least one alkaline metal amino alcoholate of Formula (I) as a ligand:

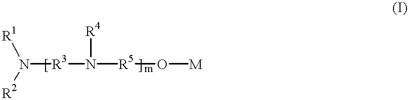

wherein:

R¹, R² and R⁴ each independently represent an alkyl radical, linear or branched, containing 1 to 8 carbon atoms, or an arylalkyl, alkylaryl radical, wherein the alkyl radicals have 1 to 8 carbon atoms, or an aryl radical;

R³ and R⁵ each independently represent an alkylene radical, linear or branched, containing 2 to 8 carbon atoms, whether or not substituted by a C₁-C₈ alkyl radical, or an aryl radical or an arylalkylene radical or an arylene radical;

M designates an alkaline metal, and

m is equal to 0 or a whole number from 1 to 6.

In Formula (I) above, R¹, R² and R⁴ each independently represent a methyl, ethyl, propyl, butyl, pentyl, hexyl, benzyl or phenyl radical, preferably methyl; R³ and R⁵ each independently represent an ethylene, propylene, butylene or isobutylene radical, preferably ethylene; M preferably represents lithium, and m is preferably equal to zero or 1.

The amino alcoholates (2) are known compounds that are prepared, for example, by reaction of a Compound (II);

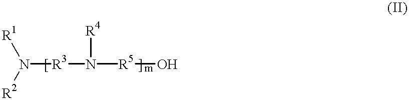

with any base, the pKa of which is greater than the pKa of the alcoholate (I)/alcohol (II) pair. Thus, lithium amino alcoholates are prepared by reacting with an organometallic compound of lithium or of metallic lithium in a polar or nonpolar solvent.

Initiator (I) of the inventive initiation system is selected from any mono- or difunctional initiator known for anionic polymerization.

The monofunctional initiator is selected, in particular, from among compounds of Formula (III):

(R⁶)ₚ—M′ (III)

wherein:

R⁶ designates a linear or branched-chain alkyl radical, containing 2 to 8 carbon atoms; or an aryl radical with one or more rings, possibly substituted; or an alkenyl radical at C₂-C₆ substituted by an aryl or an alkylaryl radical; or an alkyl radical, linear or branched, containing 1 to 8 carbon atoms, substituted by at least one phenyl radical or an alkylaryl radical, wherein the alkyl radical has 1 to 8 carbon atoms;

M′ designates an alkaline metal or an alkaline earth metal; the valence p is respectively 1 or 2;

The monofunctional initiator is also selected from an α-lithioisobutyrate and amides.

Monofunctional initiators are, for example, sec.-butyllithium, n-butyllithium, fluorenyllithium, α-methylstyryllithium, 1,1-diphenylhexyllithium, diphenylmethyllithium or -sodium or -potassium and 1,1-diphenyl-3-methylpentyllithium.

Difunctional initiators are of Formula (IV):

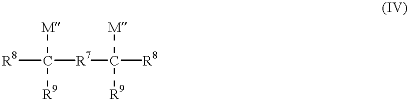

Wherein:

M″ is an alkaline metal; and

R⁷ represents an organic bivalent radical, aliphatic, cycloaliphatic, aromatic or containing at least one cycloaliphatic or aromatic radical, R⁷ may contain substituents; and

R⁸ and R⁹ each independently represent an organic monovalent radical, aliphatic, cycloaliphatic, aromatic or containing at least one cycloaliphatic or aromatic radical; R⁸ and R⁹ may contain substituents.

The difunctional initiator may be selected, in particular, from among compounds such as 1,1,4,4-tetraphenyl-1,4-dilithio-butane and 1,1,4,4-tetraphenyl-1,4-disodiobutane.

Well-known difunctional initiators, such as lithium naphthalene, sodium naphthalene, potassium naphthalene or homologues thereof may also be used.

The reaction product of two equivalents of organomonolithiated initiator (such as tert.-butyllithium) with 1,3-diisopropenyl-benzene is also used.

The molar ratio of the alkaline metal amino alcoholate (2) to the initiator (1) in the inventive initiation system may vary within rather large limits. The quantity of alcoholate (2) depends on the initiator (1) selected and the monomer(s) to polymerize. The inventive amino alcoholate/initiator molar ratio is between 1 and 200, preferably between 5 and 100, and particularly greater than 10.

This invention also concerns a process for anionic polymerization of (meth)acrylic monomers and possibly ethylenically-unsaturated monomers that are copolymerized with these (meth)acrylic monomers, characterized in that the polymerization is conducted in the presence of an initiation system as defined above.

The polymerization temperature may vary between −100° C. and +100° C., preferably between −10° C. and +90° C., and most particularly, is less than or equal to + 70° C.

Polymerization, conducted in the presence of the inventive initiation system, preferably takes place in the absence of moisture and oxygen, and in the presence of at least one aprotic solvent, preferably nonpolar or mostly nonpolar. The solvent is selected, preferably, from among benzene, toluene, ethylbenzene, tetrahydrofuran, diglyme, tetraglyme, orthoterphenyl, biphenyl, decaline, tetraline or mixtures thereof; toluene or ethylbenzene may be used advantageously. A mixture of toluene-tetrahydrofuran or ethylbenzene-tetrahydrofuran that contains up to 10% by volume of tetrahydrofuran may also be used.

The inventive initiation system permits complete conversion of the monomers within a period of less than, and generally much less than, 30 minutes; the time depends on the temperature. In the case of polymerization of acrylates, this time may be much less than one second.

Inventive polymerization is possible in batch-type or tube reactors, but is not limited to them.

It may be conducted continuously, as described in Patent Application EP-A-749987 and, in this case, the monomer(s) to be polymerized and the initiation system are first mixed in a micro-mixer (for instance, a micro-mixer of the cyclone or tangential jet type, or the impact-jet type), and the mixture is then injected into the (co)polymerization reactor. The residence time of the monomer(s) and the initiation system in the micro-mixer is less than the (co)polymerization time.

Polymerization may take place under adiabatic conditions. This is interesting since energy does not have to be provided during the course of polymerization.

Using the inventive process, homopolymers, particularly of methyl poly(methacrylate) with a triad level of at least 60%, random copolymers or block copolymers or star polymers comprising arms formed from block or random (co)polymers are produced at high temperatures.

The monomers that are (co)polymerized by the inventive process are (meth)acrylic monomers and ethylenically-unsaturated monomers that are polymerized with these (meth)acrylic monomers. The latter are selected, notably, from among vinyl-aromatic monomers, possibly substituted, for example, by halogens, diene monomers, vinylidene monomers, olefin monomers and vinyl-2 and vinyl-4-pyridine, vinylsilanes, vinylaldehydes, vinylketones, vinylsulfoxides and alkylcyanoacrylates. Heterocyclic monomers are also used.

The term “(meth)acrylic monomer”, as used here, means a monomer selected from among (meth)acrylates of the following respective formulae:

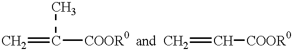

wherein R⁰ is selected from among alkyl radicals at C₁-C₁₈, linear or branched, primary, secondary or tertiary, cycloalkyl at C₅-C₁₈, alkoxy-alkyl and alkylthio-alkyl, wherein the alkyl group, linear or branched, have 1 to 8 carbon atoms, aryl and arylalkyl, these radicals possibly being substituted by at least one atom of fluorine and/or at least one hydroxyl group after protection of this hydroxyl group; the (meth)acrylates of glycidyl, norbornyl, isobornyl, mono- and di-(alkyl at C₁-C₁₈)-(meth)acrylamides.

As examples of usable methacrylates, we cite the methacrylates of methyl, ethyl, 2,2,2-trifluoroethyl, n-propyl, isopropyl, n-butyl, sec.-butyl, tert.-butyl, n-amyl, i-amyl, n-hexyl, 2-ethylhexyl, cyclohexyl, octyl, i-octyl, nonyl, decyl, lauryl, stearyl, phenyl, benzyl, β-hydroxy-ethyl, isobornyl, hydroxypropyl and hydroxybutyl. The preferred methacrylic monomer is methyl methacrylate.

As examples of acrylates of the above formula, we cite the acrylates of methyl, ethyl, n-propyl, isopropyl, n-butyl, sec.-butyl, tert.-butyl, hexyl, 2-ethylhexyl, isooctyl, 3,3,5-trimethylhexyl, nonyl, isodecyl, lauryl, octadecyl, cyclohexyl, phenyl, methoxymethyl, methoxyethyl, ethoxymethyl and ethoxyethyl.

Vinyl-aromatic monomer in the sense of this invention means an ethylenically-unsaturated aromatic monomer such as styrene, vinyltoluene, alpha-methylstyrene, methyl-4-styrene, methyl-3-styrene, methoxy-4-styrene, hydromethyl-2-styrene, ethyl-4-styrene, ethoxy-4-styrene, dimethyl-3,4-styrene, tert.-butyl-3-styrene and vinyl-1-naphthalene.

Diene monomer means a diene selected from among the linear or cyclic dienes, conjugated or unconjugated, such as, for example, butadiene, 2,3-dimethyl-butadiene, isoprene, 1,3-pentadiene, 1,4-pentadiene, 1,4-hexadiene, 1,5-hexadiene, 1,9-decadiene, 5-methylene-2-norbornene, 5-vinyl-2-norbornene, 2-alkyl-2,5-norbornadienes, 5-ethylene-2-norbornene, 5-(2-propenyl)-2-norbornene and 5-(5-hexenyl)-2-norbornene.

As an olefin monomer, we cite ethylene.

The following examples illustrate this invention, without, however, limiting the scope thereof.

In the examples, the following abbreviations were used:

MMA and PMMA=methyl methacrylate and poly(methyl methacrylate);

THF= tetrahydrofuran;

[A]₀= initial concentration of initiator;

[L]= concentration of ligand;

[M]₀= initial concentration of monomer;

DPE= 1,1-diphenylethylene;

BuLi= n-butyllithium;

DPH-Li= 1,1-diphenylhexyllithium;

M₀= molar weight of monomer;

$$- {\overline{Mn}}_{theoritical} = {M}_{0} \times \frac{{[ M ]}_{0}}{{[ A ]}_{0}} \times yield \\ - lp = \frac{\overline{Mw}}{\overline{Mn}} \\ - r = \frac{[ L ]}{{[ A ]}_{0}}$$

The amino alcoholates used are lithium 2-[N-(2-dimethylaminoethyl)-N-methylamino] ethylate (1a):

[chemical structure]

and lithium 2-(dimethylamino)ethylate (1b):

[chemical structure]

The general method is the following:

All traces of impurities (moisture, oxygen, etc.) are avoided in the system; for this, all reagents are purified as described below, degasified and held under pure nitrogen.

Methyl methacrylate (MMA) is first dried over calcium hydride (CaH₂), then a 10% solution of triethylaluminum in toluene is added until a persistent light yellow color appears. The MMA is redistilled just before use.

The toluene and THF were fractionated, then heated to reflux over potassium and introduced into a round-bottom flask linked to piping under vacuum. After degasification, the mixture was stirred with 5 ppm of benzophenone over a sodium/potassium alloy (1/3) until the solution turned blue; it was then distilled again just before use.

The initiator is obtained by reaction of one equivalent of n-butyllithium (1.3 M in solution in a mixture of cyclohexane/hexane) with one equivalent of DPE, in THF at −40° C. (or in toluene at + 30° C.).

The amino alcoholates are prepared in situ by reaction of alcohols (distilled over magnesium and preserved under nitrogen)

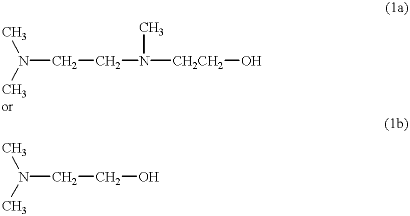

with the initiator.

All reagents are stored under nitrogen in calibrated burettes. The polymerizations are conducted in glass reactors under nitrogen.

### EXAMPLE 1

In a 500 ml reactor equipped with a magnetic stirrer, 100 ml THF under nitrogen is introduced and then a few drops of initiator DPH-Li are added until a red color appears.

Then 0.3 ml alcohol (1a) (1.85×10⁻³ mole) are added; the red color disappears instantly. The alcohol is de-protonated by adding 4 ml DPH-Li (4.6×10⁻⁴ mole/ml) drop by drop. When the red color reappears, the reaction medium is thermostatted and 0.4 ml initiator DPH-Li (r=[L]/[A]₀=10) is added. Freshly distilled MMA 5.1 ml is introduced under strong agitation. After a few minutes, polymerization is stopped by the addition of 0.5 ml methanol. The polymer is recovered by precipitation in methanol, and then dried under vacuum.

Steric-exclusion chromatographs are made on Varian equipment equipped with double detection (UV/RI) and TSK type columns calibrated with standards of polystyrene. THF is used as the eluent.

The tacticity of the polymers is determined by NMR¹H, with a Bruker AC200 (200 MHZ) device.

The results are given in Table 1.

TABLE 1
Anionic polymerization of MMA in THF with diphenylhexyllithium
as initiator and with the ligand (1a)

| | Temp. | | Yield | | | | Tacticity | | |
|---|---|---|---|---|---|---|---|---|---|
| Example | (° C.) | r | (% in weight) | \overline{Mn}_{theor.} | \overline{Mn}_{exp.} | Ip | mm | mr | rr |
| 1 | 10 | 10 | 100 | 25800 | 24768 | 1.88 | 0.06 | 0.32 | 0.62 |
| 2 | 10 | 20 | ″ | 15500 | 15190 | 1.86 | 0.03 | 0.35 | 0.62 |
| 3 | 20 | 20 | ″ | 23500 | 22560 | 2.13 | 0.08 | 0.24 | 0.68 |
| 4 | 40 | 10 | 50 | 8000 | 9680 | 2.80 | — | — | — |

rr = syndiotactic
mm = isotactic
mr = atactic
\overline{Mn} in g/mole

### EXAMPLES 2 TO 4

Proceed as for Example 1, changing the operating conditions as indicated in Table 1.

In Example 4, note that in a polar medium, with r=[L]/[A]₀ equal to 10, control over the polymerization begins to be lost only starting from + 40° C.

### EXAMPLES 5 TO 11

Proceed as in Example 1, but use alcohol 1b to form ligand 1b in situ.

The operating conditions and results are given in Table 2.

### EXAMPLES 12 TO 15

Proceed as in Example 1, but use toluene instead of THF.

The operating conditions and results are given in Table 3.

### EXAMPLES 16 TO 22

Proceed as in Examples 5 to 11, but use toluene instead of THF as the solvent.

The results are given in Table 4.

After studying the results in Tables 3 and 4 compared to those in Tables 1 and 2, it is noted that polymerization in an nonpolar medium is controlled better at high temperatures, even if the results obtained in a polar medium remain remarkable.

In Table 4, one may note that, in Examples 21 and 22, at high temperature (90° C.), control over polymerization is improved by increasing the ratio r=[L]/[A]₀.

### EXAMPLES 23 TO 27

Proceed as in Example 1, but use a mixture of toluene and THF (9/1 by volume) as the solvent.

The operating conditions and results are indicated in Table 5.

TABLE 2
Anionic polymerization of MMA in THF with diphenylhexyllithium
as Initiator and with the ligand (1b)

| | Temp. | | Yield | | | | Tacticity | | |
|---|---|---|---|---|---|---|---|---|---|
| Example | (° C.) | r | (% in weight) | \overline{Mn}_{theor.} | \overline{Mn}_{exp.} | Ip | mm | mr | rr |
| 5 | −80 | 10 | 100 | 17500 | 18200 | 1.29 | — | — | — |
| 6 | −20 | 10 | ″ | 12500 | 13500 | 1.37 | — | — | — |
| 7 | −20 | 20 | ″ | 18900 | 20601 | 1.40 | — | — | — |
| 8 | −10 | 10 | ″ | 12800 | 13056 | 1.61 | 0.04 | 0.70 | 0.26 |
| 9 | 0 | 10 | ″ | 24500 | 25480 | 1.53 | 0.06 | 0.69 | 0.25 |
| 10 | 0 | 20 | ″ | 15600 | 16068 | 1.55 | 0.05 | 0.70 | 0.25 |
| 11 | 10 | 50 | 65 | 19500 | 25935 | 1.98 | 0.09 | 0.71 | 0.20 |

rr syndiotactic
mm = isotactic
mr = atactic
\overline{Mn} in g/mole

TABLE 3
Anionic polymerization of MMA in toluene with diphenylhexyllithium
as initiator and with the ligand (1a)

| | Temp. | | Yield | | | |
|---|---|---|---|---|---|---|
| Example | (° C.) | r | (% in weight) | \overline{Mn}_{theor.} | \overline{Mn}_{exp.} | lp |
| 12 | −80 | 10 | 100 | 21600 | 158328 | 1.09 |
| 13 | 10 | 10 | ″ | 30700 | 144597 | 1.95 |
| 14 | 10 | 20 | ″ | 20000 | 94600 | 2.02 |
| 15 | 20 | 10 | ″ | 13400 | 63248 | 1.90 |

Mn in g/mole

TABLE 4
Anionic polymerization of MMA in toluene with diphenylhexyllithium
as initiator and with the ligand (1b)

| | Temp. | | Yield | | | | Tacticity | | |
|---|---|---|---|---|---|---|---|---|---|
| Example | (° C.) | r | (% in weight) | \overline{Mn}_{theor.} | \overline{Mn}_{exp.} | Ip | mm | mr | rr |
| 16 | −80 | 10 | 100 | 104000 | 19968 | 1.80 | — | — | — |
| 17 | 60 | 100 | ″ | 39300 | 37335 | 2.14 | 0.07 | 0.69 | 0.24 |
| 18 | 70 | 100 | ″ | 31000 | 29760 | 2.25 | 0.07 | 0.70 | 0.22 |
| 19 | 70 | 200 | ″ | 20000 | 19200 | 2.19 | 0.10 | 0.70 | 0.11 |
| 20 | 80 | 100 | 80 | 16000 | 21440 | 2.23 | — | — | — |
| 21 | 90 | 10 | 70 | 14000 | 20580 | 3.61 | — | — | — |
| 22 | 90 | 100 | 75 | 15000 | 20550 | 1.81 | — | — | — |

\overline{Mn} in g/mole

TABLE 5
Anionic polymerization of MMA in a mixture of toluene/THF (9/1 by volume)
with diphenylhexyllithium as initiator and with the ligand (1a)

| | Temp. | | Yield | | | | Tacticity | | |
|---|---|---|---|---|---|---|---|---|---|
| Example | (° C.) | r | (% in weight) | \overline{Mn}_{theor.} | \overline{Mn}_{exp.} | Ip | mm | mr | rr |
| 23 | 30 | 10 | 100 | 27600 | 26772 | 1.71 | 0.11 | 0.60 | 0.29 |
| 24 | 40 | 10 | 100 | 32000 | 32960 | 1.78 | 0.10 | 0.61 | 0.29 |
| 25 | 50 | 10 | 50 | 10000 | 13100 | 2.42 | — | — | — |
| 26 | 50 | 25 | 55 | 11000 | 14080 | 2.48 | — | — | — |
| 27 | 50 | 50 | 55 | 11000 | 14300 | 2.44 | — | — | — |

### EXAMPLES 28 TO 30

Proceed as in Examples 5 to 11, but use a mixture of toluene and THF (9/1 by volume).

The operating conditions and results are shown in Table 6.

As the examples show, this invention for the first time permits controlled anionic polymerization of methyl methacrylate at temperatures as high as 70° C., in a nonpolar medium, in the presence of a ligand of a new type combined with a conventional initiator.

TABLE 6
Anionic polymerization of MMA in a mixture of toluene/THF (9/1 by volume
with diphenylhexyllithium as initiator and with the ligand (1b)

| | Temp. | | Yield | | | | Tacticity | | |
|---|---|---|---|---|---|---|---|---|---|
| Example | (° C.) | r | (% in weight) | \overline{Mn}_{theor.} | \overline{Mn}_{exp.} | lp | mm | rr | mr |
| 28 | 20 | 10 | 100 | 28600 | 28028 | 1.80 | 0.06 | 0.65 | 0.29 |
| 29 | 30 | 10 | ″ | 15000 | 14400 | 1.99 | 0.05 | 0.65 | 0.30 |
| 30 | 30 | 100 | ″ | 40400 | 39188 | 1.68 | 0.09 | 0.65 | 0.27 |

Mn in g/mole

What is claimed is:

1. An Initiation system for anionic (co)polymerization of (meth)acrylic monomers and possibly ethylenically-unsaturated comonomers, comprising
(1) at least one initiator, and
(2) at least one alkaline metal amino alcoholate of Formula (I) as ligand: 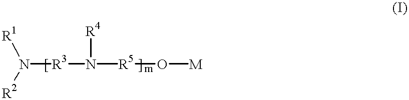
wherein:
R¹, R² and R⁴ each independently represent an alkyl radical, linear or branched, containing 1 to 8 carbon atoms or an arylalkyl, alkylaryl radical wherein the alkyl radicals have 1 to 6 carbon atoms, or an aryl radical;
R³ and R⁵ each independently represent an alkylene radical, linear or branched, containing 2 to 8 carbon atoms, whether or not substituted by a C₁-C₈ alkyl radical or an aryl radical or an arylalkylene radical or an arylene radical;
M designates an alkaline metal; and
m is equal to 0 or a whole number from 1 to 6.

2. The initiation system according to claim 1, characterized in that, in Formula (I), R¹, R² and R⁴ each independently represent a methyl, ethyl, propyl, butyl, pentyl, hexyl, phenyl or benzyl radical, preferably methyl; R³ and R⁵ each independently represent an ethylene, propylene, butylene or isobutylene radical, preferably ethylene; m is equal to 0 or a whole number from 1 to 6, and M represents lithium.

3. The initiation system according to claim 1, characterized in that the initiator(s) (1) are selected from among monofunctional initiators of Formula (III):
(R⁶)ₚ—M (III)
wherein:
R⁶ designates a linear or branched-chain alkyl radical, containing 2 to 8 carbon atoms; or an aryl radical with one or more rings, possibly substituted; or a C₂-C₆ alkenyl radical substituted by an aryl or an alkylaryl; or an alkyl radical, linear or branched, containing 1 to 8 carbon atoms, substituted by at least one phenyl group or an alkylaryl radical wherein the alkyl radical has 1 to 8 carbon atoms;
M′ designates an alkaline metal or an alkaline earth metal; valence p is respectively 1 or 2;
and the α-lithioisobutyrate and amide initiators.

4. The initiation system according to claim 3, characterized in that the monofunctional initiators are selected from among sec.-butyllithium, n-butyllithium, fluorenyllithium, alpha-methylstyryllithium, 1,1 -diphenylhexyllithium, diphenylmethyllithium or -sodium or -potassium and 1,1-diphenyl-3-methylpentyllithium.

5. The initiation system according to claim 1, characterized in that the initiators (1) are selected from among difunctional initiators of Formula (IV): 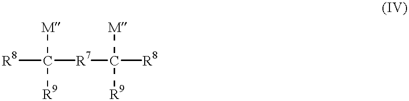
Wherein:
M″ is an alkaline metal; and
R⁷ represents an organic bivalent radical, aliphatic, cycloaliphatic, aromatic or containing at least one cycloaliphatic or aromatic group, R⁷ may contain substituents; and
R⁸ and R⁹ each independently represent an organic monovalent radical, aliphatic, cycloaliphatic, aromatic or containing at least one cycloaliphatic or aromatic group, R⁸ and R⁹ may contain substituents.

6. The initiation system according to claim 5, characterized in that the difunctional initiator(s) are selected from between 1,1,4,4-tetraphenyl-1,4-dilithiobutane and 1,1,4,4-tetraphenyl-1,4-disodiobutane.

7. The initiation system according to claim 1, characterized in that the difunctional initiator(s) (1) are selected from among the precursors of difunctional initiators, lithium naphthalene, sodium naphthalene, potassium naphthalene or the product of the reaction of two equivalents of organomonolithiated initiator with 1,3-diisopropenylbenzene.

8. The initiation system according to claim 1, characterized in that the molar ratio of amino alcoholate (2) to initiator (1) is between 1 and 200, inclusive, and preferably between 5 and 100.

9. A process for anionic (co)polymerization of (meth)acrylic monomers and possibly ethylenically-unsaturated comonomers, characterized in that the polymerization is conducted in the presence of an initiation system comprising
(1) at least one initiator, and
(2) at least one alkaline metal amino alcoholate of Formula (I) as ligand: 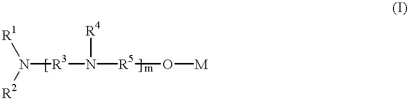
wherein:
R¹, R² and R⁴ each independently represent an alkyl radical, linear or branched, containing 1 to 8 carbon atoms or an arylalkyl, alkylaryl radical wherein the alkyl radicals have 1 to 6 carbon atoms, or an aryl radical;
R³ and R⁵ each independently represent an alkylene radical, linear or branched, containing 2 to 8 carbon atoms, whether or not substituted by a C₁-C₈ alkyl radical or an aryl radical or an arylalkylene radical or an arylene radical;
M designates an alkaline metal; and
m is equal to 0 or a whole number from 1 to 6.

10. The process according to claim 9, characterized in that it is conducted at a temperature of between −100° C. and +100° C., preferably at a temperature of between −10° C. and +90° C.

11. The process according to claim 9, characterized in that it is conducted in at least one aprotic solvent, polar or nonpolar, preferably nonpolar or mostly nonpolar.

12. The process according to claim 11, characterized in that the solvent is selected from among benzene, toluene, ethylbenzene, tetrahydrofuran, diglyme, tetraglyme, orthoterphenyl, biphenyl, decaline, tetraline or mixtures thereof, particularly toluene, ethylbenzene or a mixture of toluene-tetrahydrofuran or ethylbenzene-tetrahydrofuran that may contain up to 10% by volume of tetrahydrofuran.

13. The process according to claim 9, characterized in that it is conducted for a period of less than 30 minutes.

14. The process according to claim 9, characterized in that the (meth)acrylic monomers are selected from among the (meth)acrylates of the formulae, respectively: 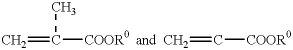
wherein R⁰ is selected from among alkyl radicals at C₁-C₁₈, linear or branched, primary, secondary or tertiary, C₅-C₁₈ cycloalkyl, alkoxyalkyl and alkylthio-alkyl wherein the alkyl groups, linear or branched, have 1 to 8 carbon atoms, aryl and arylalkyl, these groups possibly being substituted by at least one atom of fluorine and/or at least one hydroxyl group after protection of this hydroxyl group; the (meth)acrylates of glycidyl, norbornyl, isobornyl, mono- and di-(C₁-C₁₈) alkyl (meth)acrylamides.

15. The process according to claim 14, characterized in that the methacrylic monomers are selected from among the methacrylates of methyl, ethyl, 2,2,2-trifluoroethyl, n-propyl, isopropyl, n-butyl, sec.-butyl, tert.-butyl, n-amyl, i-amyl, n-hexyl, 2-ethylhexyl, cyclohexyl, octyl, i-octyl, nonyl, decyl, lauryl, stearyl, phenyl, benzyl, β-hydroxy-ethyl, isobornyl, hydroxypropyl and hydroxybutyl.

16. The process according to claim 14, characterized in that the acrylic monomers are selected from among the acrylates of methyl, ethyl, n-propyl, isopropyl, n-butyl, sec.-butyl, tert.-butyl, hexyl, 2-ethylhexyl, isooctyl, 3,3,5-trimethylhexyl, nonyl, isodecyl, lauryl, octadecyl, cyclohexyl, phenyl, methoxymethyl, methoxyethyl, ethoxymethyl and ethoxyethyl.

17. The process according to claim 9, characterized in that the monomers that are copolymerized with the (meth)acrylic monomers are selected from among the vinylaromatic monomers, diene monomers, vinylidene monomers, olefinic monomers, vinyl-2 and vinyl-4-pyridines, vinylsilanes, vinylaldehydes, vinylketones, vinylsulfoxides, alkylcyanoacrylates and heterocyclic monomers.

18. The process according to claim 9, characterized in that the methyl methacrylate is polymerized in the presence of an nonpolar or mostly nonpolar solvent.

19. The process according to claim 18, characterized in that a methyl poly(meth)acrylate is obtained with a level of syndiotactic triads of at least 60%.
